(19) United States
(12) Patent Application Publication
(10) Pub. No.: US 2014/0157915 A1
(43) Pub. Date: Jun. 12, 2014

(54) GANTRY APPARATUS

(71) Applicant: Beckman Coulter, Inc., Brea, CA (US)

(72) Inventors: Lutz Gross, Munich (DE); Martin Mueller, Schliersee-Neuhaus (DE); Chad Owens, Clinton, IN (US)

(73) Assignee: Beckman Coulter, Inc., Brea, CA (US)

(21) Appl. No.: 14/099,151

(22) Filed: Dec. 6, 2013

Related U.S. Application Data
(60) Provisional application No. 61/734,344, filed on Dec. 6, 2012.

(51) Int. Cl. F16M 13/00; B01L 3/02; F16C 29/00

(52) U.S. Cl. CPC F16M 13/00; F16C 29/00; B01L 3/021
USPC 73/864.01; 248/323; 248/327; 384/26

(57) ABSTRACT

An X-Y gantry system is disclosed. The X-Y gantry system includes an X-axis element, a Y-axis element coupled to the X-axis element. An instrument is coupled to the Y-axis element. The Y-axis element includes a slider assembly with a slider and a guide support element coupled to the slider. The guide support element may have a flexible portion. The slider may or may not contact a slider bar in the system.

### CROSS-REFERENCES TO RELATED APPLICATIONS

This application claims the benefit or and is a non-provisional application of U.S. provisional patent application No. 61/734,344, filed on Dec. 6, 2012, which is herein incorporated by reference in its entirety for all purposes.

### BACKGROUND

X-Y gantry systems are used to position objects within a working environment. An exemplary working environment is a laboratory environment. Sample containers and instruments can be moved to and from different locations within the laboratory environment. A number of different gantry systems have been previously proposed, and a number of improvements can be made to conventional gantry systems. Some conventional generic gantry systems are shown in FIGS. 1A and 1B.

Referring to FIG. 1A, some conventional gantry systems use an arrangement in which one linear axis element (e.g., a Y-axis) 16 has two spaced portions. Sliders 17(a), 17(b) associated with a second axis element (hereinafter called an X-axis) comprising two linear assemblies 14(a), 14(b) are mounted at the spaced portions on the two linear assemblies. An instrument 18 (e.g., a gripper, pipettor, etc.) may be attached to a slider associated with the Y-axis element 16. As shown in FIG. 1A, the H-shaped arrangement requires a guiding system at both connection points. The supporting structure which carries the guiding system needs to be as large as the Y-axis itself or needs to be separated into two parts. This particular configuration can result in higher manufacturing and assembly costs for a reliable system.

FIG. 1B shows a cross-shaped arrangement of an X-Y gantry system. It shows an X-axis element 24, perpendicular to a Y-axis element 26. An instrument 28 may hang down from the Y-axis element 26 in the Z direction.

In FIG. 1B, a first slider 22 can be adapted to move the Y-axis element 26 along the X-axis corresponding to the orientation of the X-axis element 24. A second slider 25 can move the instrument 28 along a Y-axis corresponding to the Y-axis element 26.

The X-Y gantry system shown in FIG. 1B allows for the use of a single motor for each axis and integrates the guiding system on a single smaller support structure. This arrangement saves on space and expense. Typically, a more sophisticated support structure design is needed to achieve the requisite stiffness in an arrangement such as that shown in FIG. 1B.

A number of improvements can be made with respect to the above described designs. For example, the sliders in X-Y gantry systems are moving parts and will wear and break down over time. Because of this configuration, it is difficult to replace and service the moving parts in such conventional systems. Further, debris can be generated by the moving parts of the conventional X-Y gantry systems. As is apparent from the conventional X-Y gantry system configurations shown in FIGS. 1A and 1B, the debris that is produced from the moving parts of the system can be deposited on the system components below the X-Y gantry system, thus increasing the risk of contamination. This can be problematic in a laboratory environment where it is desirable to keep samples free of contamination.

Embodiments of the invention address these and other problems, individually and collectively.

### BRIEF SUMMARY

Embodiments of the present invention are directed to improved X-Y gantry systems as well as slider assemblies that can be used in them. Embodiments of the invention solve a number of problems, which include but are not limited to precise positioning of an analytic subassembly or other instrument (e.g., a gripper) within an analytical system (e.g., a medical analysis system) with a large work envelope. Embodiments of the invention can be less complex and more rigid than conventional X-Y gantry systems (as compared to the X-Y gantry system of FIG. 1A). Embodiments of the invention can also reduce costs and potential contamination due to debris relative to conventional X-Y gantry systems (i.e., compared to the systems like those shown in FIGS. 1A and 1B). Further, embodiments of the invention make it easier to replace sliders on a common slider bar, and can also provide for a simple manufacturing process as well as easy axis replacement. Lastly, embodiments of the invention provide for improved thermal properties. In embodiments of the invention, heat is dissipated more readily, thus reducing the possible failure of the moving parts of the system due to overheating or excessive expansion and contraction of the moving parts.

One embodiment of the invention is directed to an X-Y gantry system comprising an X-axis element comprising a casted structure, a slider bar parallel to the casted structure, and a slider slidably engaged with the slider bar. A Y-axis element is coupled to the X-axis element. An instrument is coupled to the Y-axis element. The slider bar can be on an opposite side of the casted structure, relative to the instrument. In some cases, the slider bar is above the casted structure.

Another embodiment of the invention is directed to a method for using the X-Y gantry system described above.

Another embodiment of the invention is directed to a slider assembly comprising a slider and a guide support element coupled to the slider. The guide support element comprises a main body and a flexible portion extending away from the main body.

Another embodiment of the invention is directed to an X-Y gantry system including the above-described slider assembly.

Another embodiment of the invention is directed to an X-Y gantry system comprising an X-axis element comprising a casted structure, a slider bar comprising a plurality of magnets, wherein the slider bar is parallel to and coupled to the casted structure, and a slider having an electromagnetic device. The X-Y gantry system further comprises a Y-axis element coupled to the X-axis element, and a holding frame. The slider is proximate to the slider bar and is capable of sliding along the slider bar without physically contacting the slider bar.

These and other embodiments of the invention are described in further detail below, with reference to the drawings.

### BRIEF DESCRIPTION OF THE DRAWINGS

FIG. 1A shows a perspective view of a conventional X-Y gantry system.

FIG. 1B shows a top perspective view of another conventional X-Y gantry system.

FIG. 2A shows a top perspective view of an X-Y gantry system according to an embodiment of the invention.

FIG. 2B shows a top perspective view of another X-Y gantry system according to another embodiment of the invention.

FIG. 3A shows a cross-sectional view of a portion of an X-Y gantry system according to an embodiment of the invention, without an instrument illustrated.

FIG. 3B shows a cross-sectional view of a portion of an X-Y gantry system according to an embodiment of the invention, with an instrument illustrated.

FIG. 4 shows a top perspective view of an X-Y gantry system according to an embodiment of the invention. The X-Y gantry system comprises multiple sliders on one common magnetic slider bar.

FIGS. 5A-5B respectively show top perspective views of preassembled X-axis and Y-axis elements.

FIG. 6A shows a bottom perspective view of an end portion of a casted structure.

FIG. 6B shows a perspective view of a portion of a frame with a casted structure attached to the frame.

FIG. 6C shows a perspective view of a plate assembly attached to a portion of a frame.

FIG. 7 shows a top perspective view of a preassembled Y-axis element.

FIG. 8 shows a top perspective view of a mounting interface between an X-axis and a Y-axis element.

FIG. 9 shows a top perspective view of a slider assembly according to an embodiment of the invention.

FIG. 10A shows a perspective view of a support element according to an embodiment of the invention with a thermal profile.

FIG. 10B a side, cross-sectional view of the support element in FIG. 10A without a thermal profile.

FIG. 10C a side, cross-sectional view of the support element in FIG. 10A with a thermal profile.

FIG. 11A shows a perspective view of a top guide support element according to an embodiment of the invention.

FIG. 11B shows a cross-sectional perspective view of a portion of the guide support element shown in FIG. 11A.

FIG. 12 shows a perspective, partial cross-sectional view of a portion of an X-Y gantry system according to an embodiment of the invention. This embodiment utilizes a U-shaped magnetic bar that is vertically oriented and is under a casted structure.

FIG. 13 shows a cross-sectional perspective view of an X-Y gantry system according to an embodiment of the invention. This embodiment utilizes a U-shaped magnetic bar that is horizontally oriented and is over a casted structure.

FIG. 14 shows a perspective view of the X-Y gantry system shown in FIG. 13.

FIG. 15 shows a cross-sectional perspective view of an X-Y gantry system according to an embodiment of the invention. This embodiment utilizes a U-shaped magnetic bar that is horizontally oriented, and is under a casted structure.

FIG. 16 shows a cross-sectional perspective view of an X-Y gantry system according to an embodiment of the invention. This embodiment utilizes a U-shaped magnetic bar that is horizontally oriented and is under a casted structure.

In the Figures, like numerals may designate like elements. Some descriptions of elements with like numerals may not be repeated.

### DETAILED DESCRIPTION

One embodiment of the invention is directed to an X-Y gantry system comprising an X-axis element comprising a casted structure, a slider bar parallel to and above the casted structure, and a slider slidably engaged with the slider bar. The X-Y gantry system also comprises a Y-axis element coupled to and movable with respect to the X-axis element, and an instrument coupled to the Y-axis element.

The X-Y gantry systems may be used in any suitable environment including manufacturing and laboratory automation environments.

Prior to discussing specific embodiments of the invention, some descriptions of some terms may be useful.

A “casted structure” may include any suitable structure that is formed. A suitable casted structure may be formed of any suitable material including metal. Casted structures may assume any suitable shape or configuration. In some cases, a casted structure may have an undulated profile (viewed from a radial cross section) or may be substantially flat. The structure may be formed in any suitable manner including molding. Casted structures are typically linear and have aspect ratios greater than about 3:1.

An “instrument” may include any suitable device that may include a tool for performing any suitable task. Examples of instruments include pipettors, robotic arms, cameras, etc. Some instruments may include a device that allows another part of the instrument to move in a Z-direction (e.g., up or down). The Z-direction may be perpendicular to X and Y axes corresponding to X axis and Y axis elements.

A “guide support element” may include any suitable structure that can help to guide a slider as it moves along a slider bar. It can also provide stability to the slider as it moves along the slider bar in operation. Guide support elements may have any suitable shape and may provide support for a slider and may also act as a heat sink for the slider.

A “slider” may include any suitable device that can move along a slider bar. Typical sliders include an aperture that can be used to receive a slider bar. The slider may or may not be in contact with the slider bar. The slider bar may have magnets embedded therein, and the slider may include an electromagnetic device that is coupled to a power source. Control of the electromagnetic device can control the movement of the slider along the slider bar.

A “slider bar” may include any suitable linear structure. Suitable slider bars may include magnets embedded within or attached to a support structure. Slider bars can include round, U-shaped, square, etc. radial cross-sections. In embodiments of the invention, a slider can travel alongside a slider bar in operation.

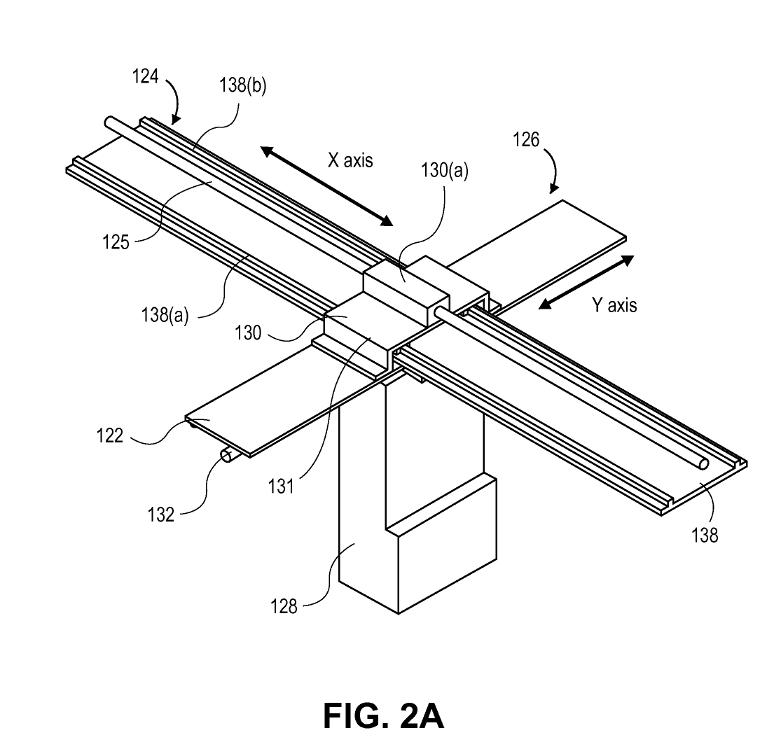

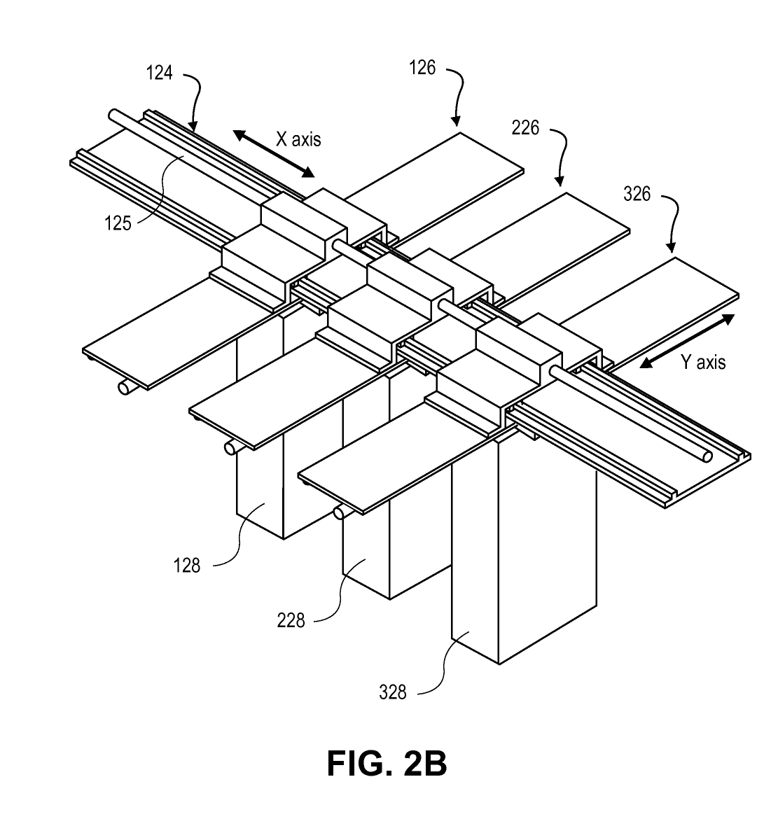

FIG. 2A shows a perspective view of an X-Y gantry system according to an embodiment of the invention. FIG. 2A shows an X-axis element 124 perpendicular to a Y-axis element 126. The X-axis element 124 may be coupled to the Y-axis element 126 through a first slider assembly 130. In some embodiments, the X-axis element 124 may be stationary and supported by an outer frame (not shown). The entire Y-axis element 126 may move along the X-axis corresponding to the X-axis element 124. An instrument 128 may be coupled to a slider assembly (not shown) to allow the instrument 128 to move along the Y-axis. Consequently, the instrument 128 may be transported in the X-direction and/or Y-direction

In this example, the X-axis element 124 comprises a substantially flat casted first structure body structure 138 comprising a pair of integral protruding linear rails 138(a), 138(b). An X-axis slider bar 125 is positioned above the casted body structure 138 and lies between the rails 138(a), 138(b) when viewed from the top. The X-axis slider bar 125 may comprise a number of embedded magnets. The X-axis element 124 also includes the first slider assembly 130 comprising a slider 130(a), which is movably coupled to the X-axis slider bar 125 that passes through a block portion of the slider 130(a). The slider 130(a) may comprise an electromagnetic device (not shown) which can allow it to move relative to the slider bar 125. A wire (not shown) may extend from the slider 130(a) so that the electromagnetic device in the slider 130(a) receive power from a power source (not shown).

The slider 130(a) is detachably coupled to an X-axis guide support element 131 so that it can be easily removed and serviced if necessary. The X-axis guide support element 131 has opposite ends that are coupled to a top surface of a second linear, substantially flat casted structure 122 in the Y-axis element 126.

The Y-axis element 126 comprises the flat body structure 122 as well as a Y-axis slider bar 132. A second slider assembly (now shown) can travel along the Y-axis slider bar 132. The second slider assembly can connect an instrument 128 to the Y-axis slider bar 132, so that the instrument 128 can move along the Y-axis. In some embodiments, the instrument 128 may also have the ability to move in a Z-direction to manipulate materials or items underneath the X-Y gantry system.

Methods of using the X-Y gantry system may include moving an instrument along a Y-axis using a Y-axis element, and also moving the instrument along an X-axis using an X-axis element. If desired, the instrument may also move in a Z-direction to allow the instrument to interact with other devices below the X-Y gantry.

The X-Y gantry system may also be controlled by a computer apparatus (not shown) comprising a processor and a computer readable medium comprising code, executable by the processor, for implementing any of the methods described herein. The processor may provide an appropriate signal to the electromagnetic devices in the sliders to cause the sliders to move in predetermined directions.

FIG. 2B shows an X-Y gantry system that is similar to the one shown in FIG. 2A, except that three Y-axis elements 126, 226, 326 are shown as being slidably engaged with a single X-axis element 124. Also, three instruments 128, 228, 328 are coupled to the three Y-axis elements 126, 226, 326, respectively. The instruments 128, 228, 328 may be of the same or different types. By using many different instruments and Y-axis elements, multiple operations may be performed by multiple instruments within the system.

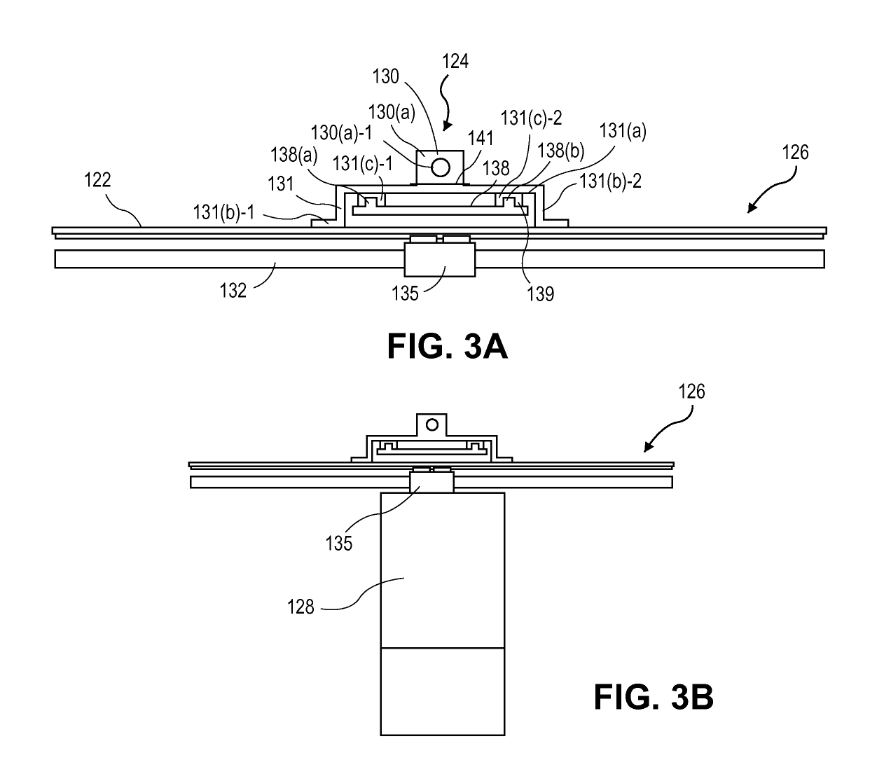

FIG. 3A shows a cross sectional view of the slider assembly 130 and other components in the system shown in FIG. 2A. The slider assembly 130 comprises a slider 130(a) including a block portion with an aperture 130(a)-1 for receiving a slider bar. The slider 130(a) is attached to an X-axis guide support element 131. An interface 141 is formed by the joining of the slider 130(a) and the X-axis guide support element 131, when they are coupled together. The slider 130(a) and the X-axis guide support element 131 may be temporarily coupled together using any suitable mechanism (e.g., screws, bolts, etc.). The slider 130(a) may be advantageously separated from the X-axis guide support element 131 (e.g, for cleaning or repair), without disassembling the X-axis guide support element 131 and the Y-axis element 126.

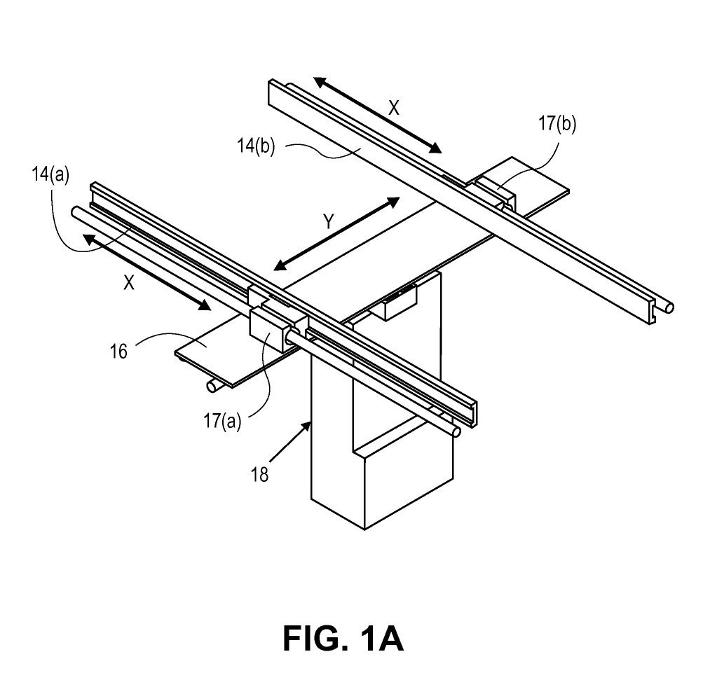

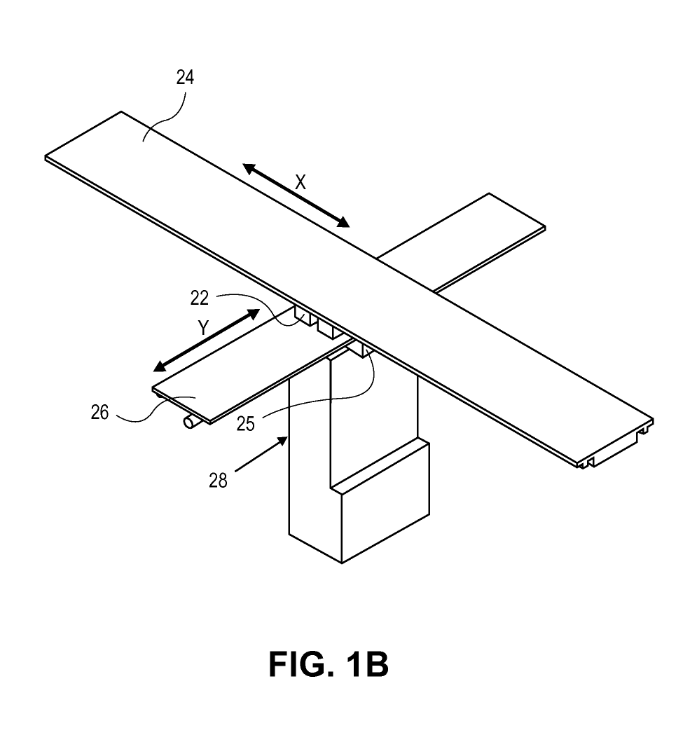

The X-axis guide support element 131 can have a concave structure, which may be defined by a horizontal main portion 131(a) and a pair of legs 131(b)-1, 131(b)-2 integrally formed with the horizontal main portion 131(a). The pair of legs 131(b)-1, 131(b)-2 may each include a vertical and horizontal portion. The horizontal portions of the legs 131(b)-1, 131(b)-2 may couple to the upper surface of the flat casted body structure 122 of the Y-axis element 126. The main portion 131(a) of the X-axis guide support element 131 may be flat and may be attached to the slider 130(a) using a temporary coupling device (e.g., screws, bolts, etc.). Two U-shaped linear guides 131(c)-1, 131(c)-2 may be coupled to or integrally formed at the bottom of the main portion 131(a) of the X-axis guide support element. Concave surfaces of the U-shaped linear guides 131(c)-1, 131(c)-2 may face downward. Protruding rails 138(a), 138(b) may be cooperatively structured with U-shaped linear guides 131(c)-1, 131(c)-2. As noted above in the description of FIG. 1A, the protruding rails 138(a), 138(b) may be part of the body structure 138 and may protrude from a main portion of the body structure 138.

The Y-axis element 126 may also include a Y-axis slider bar 132 that is coupled to the flat casted body structure 122. A second slider assembly 135 may slide along the slider bar 132, so that an instrument 128 (see FIG. 3B) can be transported along a Y-axis. The instrument 128 may have or be coupled to a device which provides movement in a Z-direction.

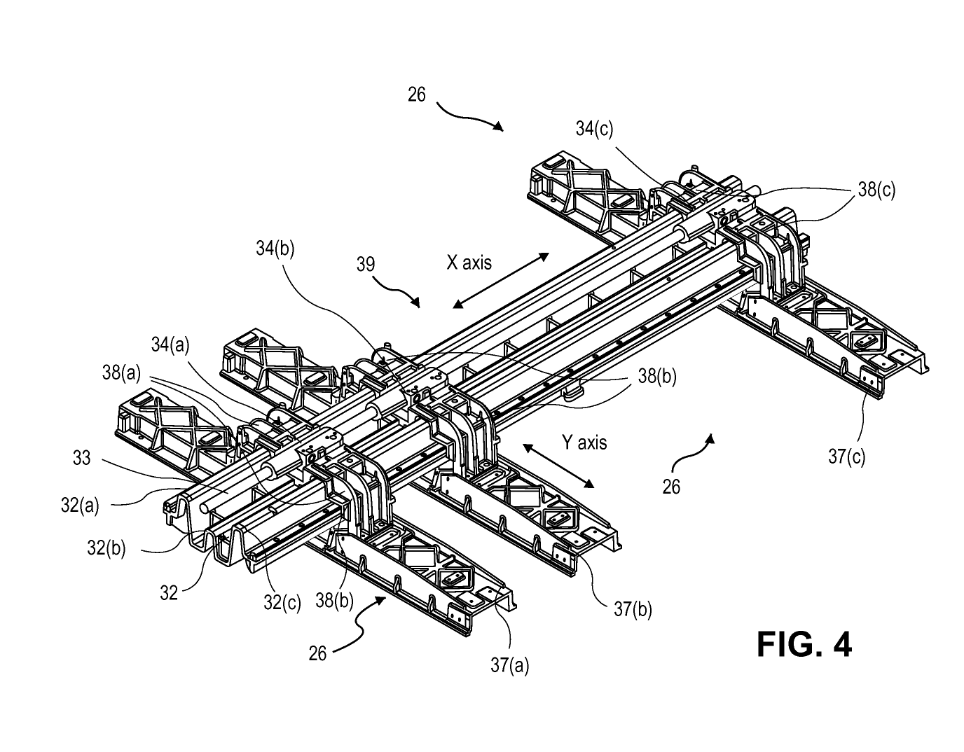

FIG. 4 shows a top perspective view of an X-Y gantry system according to an embodiment of the invention. It shows one X-axis element 39, and three Y-axis elements 37(a), 37(b), 37(c) perpendicular to the X-axis element 39. The three Y-axis elements 37(a), 37(b), 37(c) can move with respect to the X-axis element 39. In this exemplary system, space and costs can be reduced by the use of a shared X-axis slider bar 33. The illustrated X-Y gantry system allows for the usage of multiple sliders 34(a), 34(b), 34(c) sharing one common magnetic slider bar 33. The slider bar 33 can have magnets (not shown) embedded therein to allow each slider 34 to move. In this example, the slider bar 33 has a cylindrical radial cross-section. Each slider 34(a), 34(b), 34(c) can include an electromagnetic device, which can interact with the magnets in the slider bar 33 allowing the slider 34 to move. Each slider 34(a), 34(b), 34(c) can have associated with it an X-axis guide support element 38(a), 38(b), 38(c) to form a slider assembly.

Motors in the sliders 34(a), 34(b), 34(c) (like any other parts) can be affected by manufacturing tolerances. Multiple sliders 34(a), 34(b), 34(c), which can be mounted ideally in one line, can have a certain deviation with respect to each other. That deviation can lead to an increased wear in the early phase of the operation like commissioning or after replacements. In embodiments of the invention, the increased debris that is created can be prevented from falling into the area were samples are located, so that the samples are not potentially contaminated. This is achieved by housing a drive system (including the sliders) in or above the casted structure 32.

As noted above, debris can be produced by moving parts in an X-Y gantry system. For example, debris may be produced by sliders that are coupled to slider bars. The sliders may have slide bearings, and debris can be produced by the abrasion of the slide bearings as the sliders slides on the slider bar. The peaks can also help to enclose the moving elements and encapsulate any debris.

In this example, the casted structure 32 can have a radial cross-sectional configuration that has an undulated profile. As shown in FIG. 4, it can have a number peaks 32(a), 32(b), 32(c) and valleys. The slider bar 32 (and sliders) can reside in one of the valleys, and a number of guide support elements 38(a), 38(b), 38(c) can attached to outer peaks 32(a), 32(c). The slider bar 33 is present in a valley between adjacent peaks 32(a), 32(b). The region between peaks 32(b), 32(c) can help guide the movement of the guide support elements 38(a), 38(b), 38(c) as they move along the X-axis.

Compared to the embodiments in FIGS. 2A and 2B, the embodiment shown in FIG. 4 provides more stability to the X-axis of the gantry system. That is, the undulated cross-section of the casted structure 32 provides for the ability to contain any debris that may result from the movement of the sliders 34(a), 34(b), 34(c) and/or their respective guide support elements 38(a), 38(b), 38(c).

The embodiments of the invention that are shown in FIGS. 2A, 2B and 4 can also make it easy to replace a slider bar and/or slider containing the bar. For example, as shown in FIG. 4, since the X-Y gantry allows for the use of multiple sliders sharing one common magnetic slider. If a single slider fails, the slider and guide support element mounted to it can be temporarily removed. To minimize the service needed for such an operation, the design according to embodiments of the invention allow for the removal of the sliders and the slider bar upwards from the top side. No other structural parts except cables and fasteners need to be removed. The feature is achieved by a special design of the slider assembly support as an aluminum casted part.

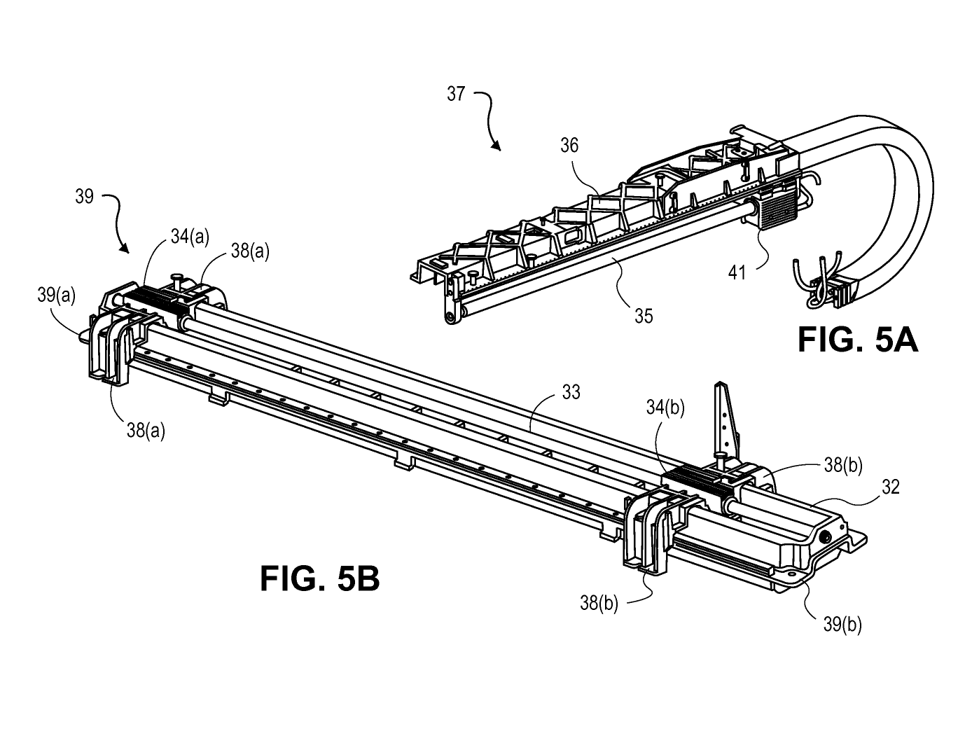

The embodiments of invention shown in FIG. 4 also provide for simple manufacturing and axes replacement. For example, in embodiments of the invention, as shown in FIGS. 5A and 5B, the X-Y gantry design can allow for the use of preassembled X and Y-axis elements 37, 39 separated from each other. Usually, the X-axis element 39 is mounted to a machine frame (not shown) in a first step. The alignment of the frame and the X-axis element 39 is designed to fit without the need for manual adjustments.

In FIG. 5A, the Y-axis element 37 comprises a holding frame 36 that is attached to a second slider bar 35, which is below the holding frame 36. The holding frame 36 may include a structure that has any suitable size and any suitable configuration. A slider assembly 41 can slide on the second slider bar 35, and an instrument (not shown) may be attached to the slider bar 35.

In FIG. 5B, the X-axis element 39 comprises a casted structure 32 that forms a trough, and partially surrounds a slider bar 33. A number of sliders 34(a), 34(b) are configured to slide on the slider bar 33, and are respectively coupled to guide support elements 38(a), 38(b). The casted structure 32 has opposing ends 39(a), 39(b), which can be mounted to a frame (not shown in FIGS. 5A and 5B).

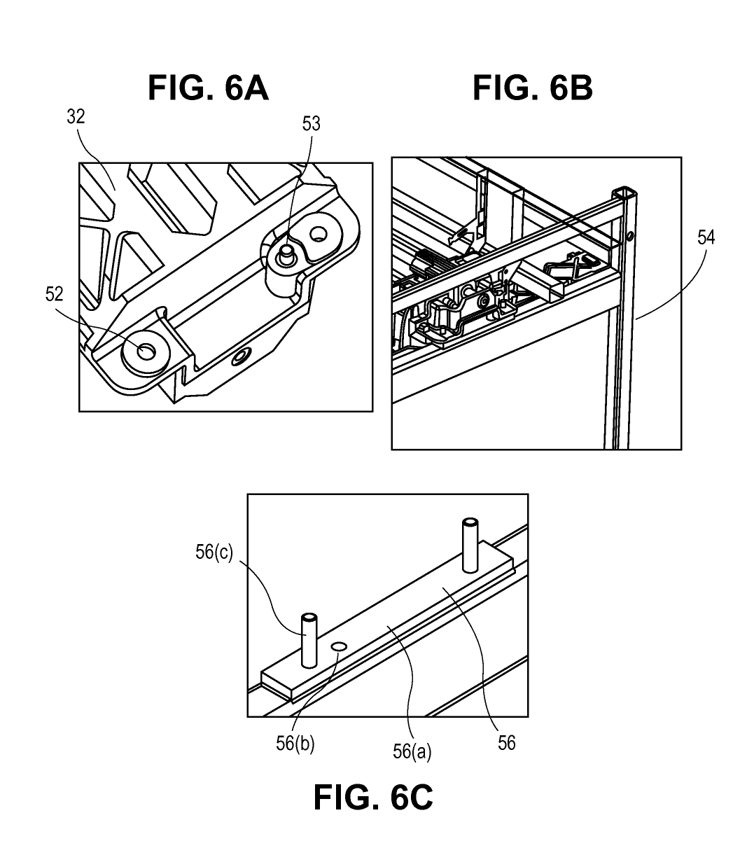

As shown in FIGS. 6A-6C, the ends of the casted structure 32 of each X-axis element contains cylinder shaped elements 53, which can be formed by machining or could be formed by parallel pins. Those elements 53 fit into a counterpart 56(b) that is attached to a plate 56(a) in a plate assembly 56. The plate assembly 56 can have pins 56(c) and can be mounted to a frame 54. The pins 56(c) can be inserted into holes 52 in the casted structure 32. To allow an axis element to be handled manually, the interface of the axis element can be designed to use the fasteners for a rough pre-alignment before the pin-hole connection becomes effective.

The Y-axis element 37 can be mounted to the X-axis element 39 in a later state of the system assembly. The design also allows for a rapid replacement of a Y-axis element if service or maintenance is needed. The mounting interface can use a keyhole shaped cut-out in combination with a standard shoulder screw.

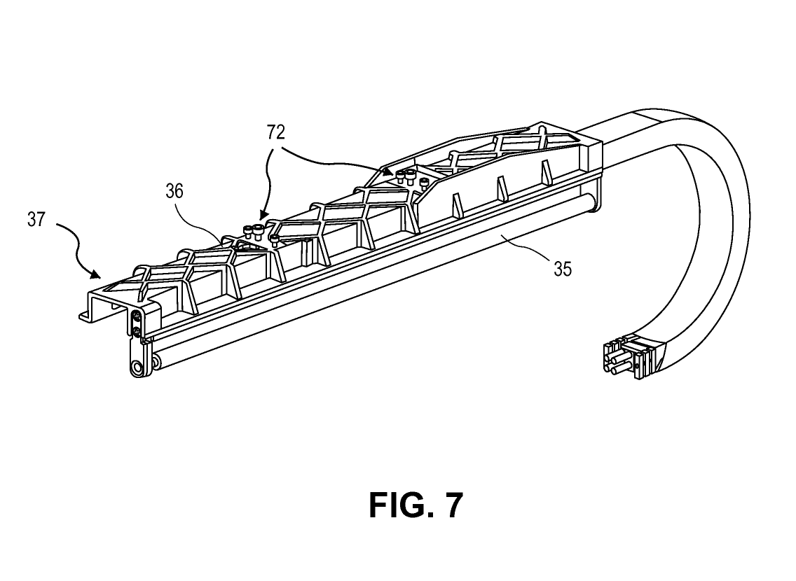

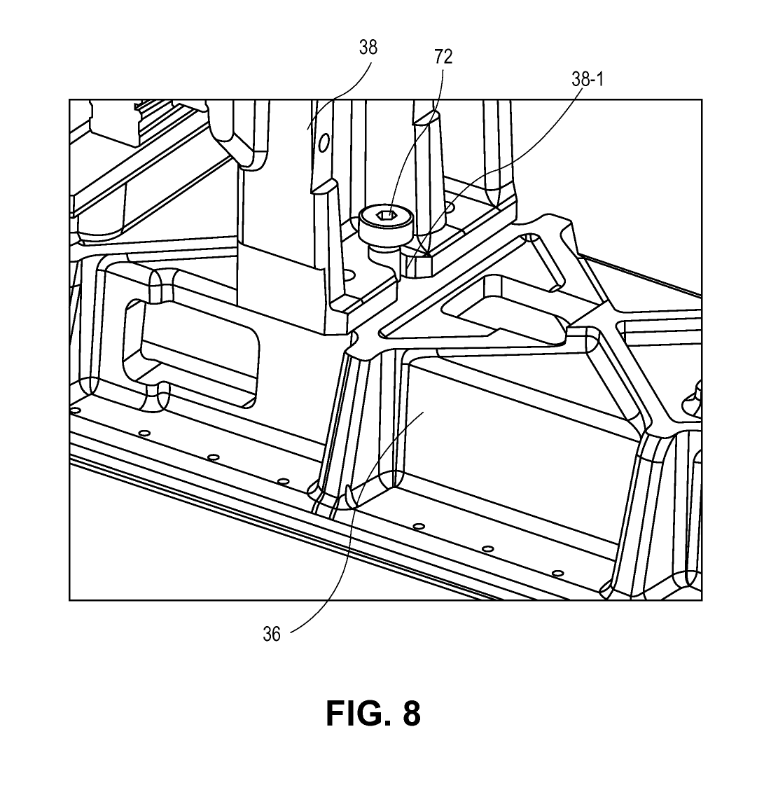

FIG. 7 shows a Y-axis element 37 comprising a holding frame 36, which is secured to other components in the Y-axis element by shoulder screws 72. The heads of the screws 72 may be spaced from the upper surface of the holding frame 36.

As shown in FIG. 8, a keyhole cut out 38-1 in the X-axis guide support element 38 receives a screw 72 in the holding frame 36. The screw 72 can be screwed in so that the head of the screw 72 and the top of the holding frame sandwich the portion of the guide support element that defines the cut out 38-1, thereby securing the Y-axis element 37 to the X-axis element 39.

This feature fulfills a number of functions. First, the head portion of the screw is used as a temporarily hold that provides for hands-free operation for the worker. Second, the precise tolerated shoulder portion is used to align the Y-axis element with the X-axis element to realize a precise rectangular fit without manual adjustments.

Other embodiments of the invention may be directed to a novel slider assembly. A slider in an X-Y gantry system can produce a greater amount of heat than a classical rotating motor with the same power. The reason for this is the lower efficiency caused by a necessarily larger gap in the magnetic circuit and the less effective heat transmission of encapsulated coils which are not in contact with flowing media. In moving slider applications as in gantry systems, the drive system requires that the slider, which contains the coils, is mounted to a moving Y-axis guide support element to form a slider assembly.

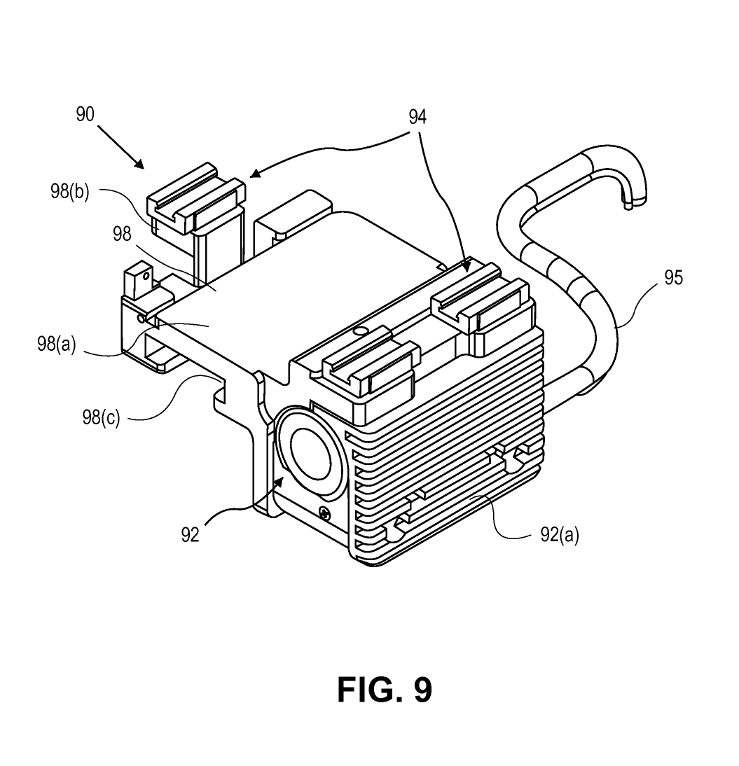

FIG. 9 shows a slider assembly 90 including a slider 92 that is guided by linear guides 94 and that is attached to a Y-axis guide support element 98. The guide support element 98 comprises a main body 98(a), and a flexible portion 98(b) coupled to or integrally formed with respect to the main body 98(a). The main body 98(a) also defines a channel 98(c).

The guide support element may be formed by any suitable method. Suitable methods may include casting, molding, shaping, etc.

The linear guides 94 may be coupled to or may be integrally formed with respect to the main body 98(a). A connector (not shown) which connects an instrument may fit within the channel 98(c) so that the instrument may be secured to the slider assembly 90.

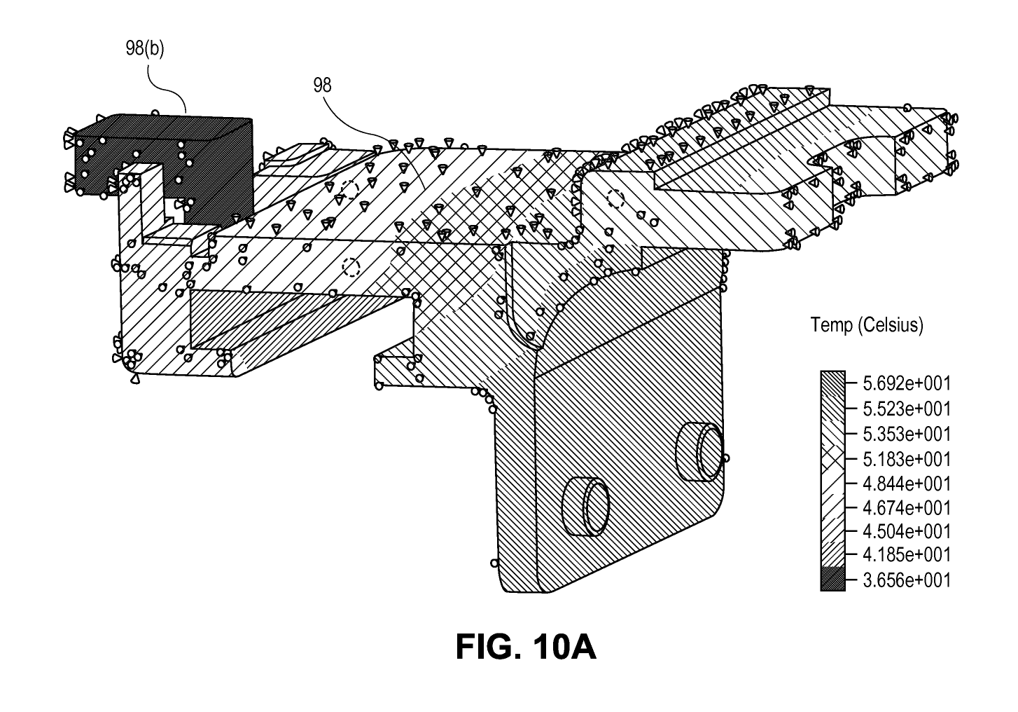

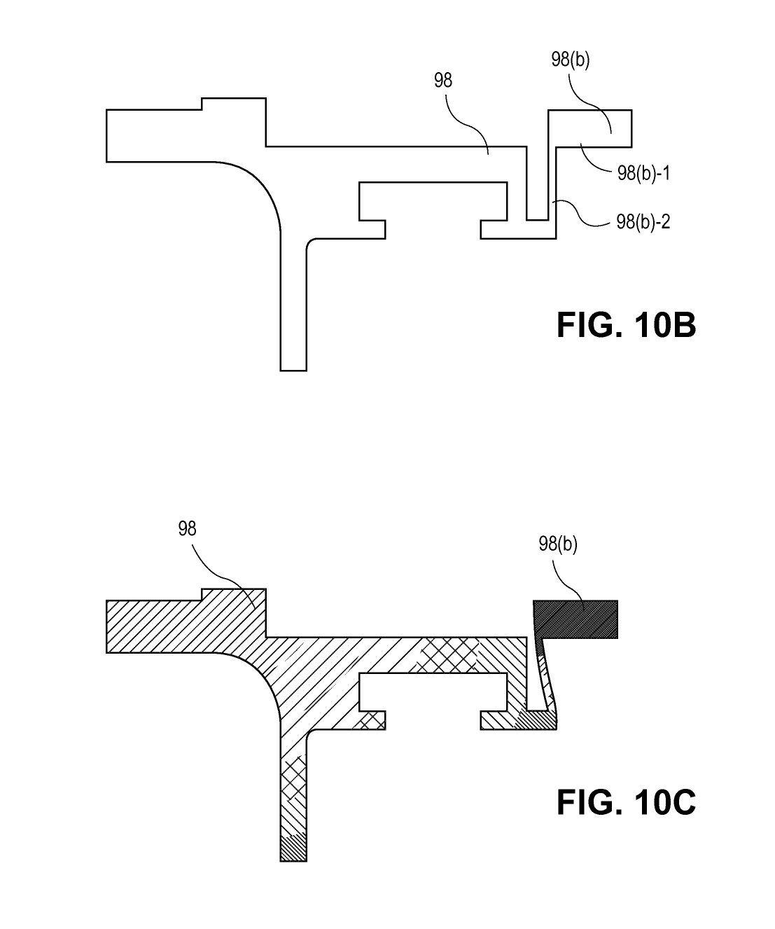

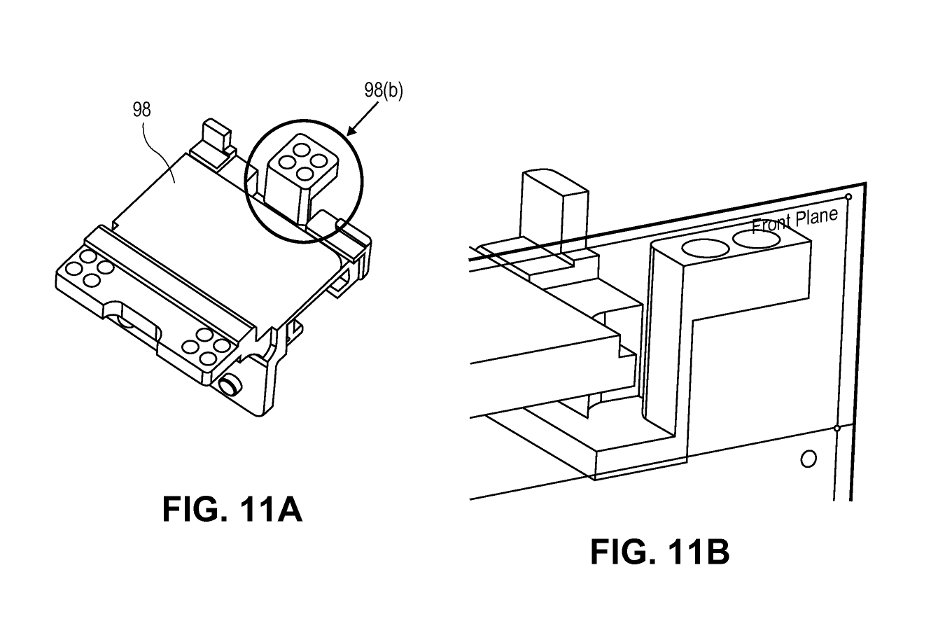

Heat that produced by the slider 92 passes into the Y-axis guide support element 98 and to the linear guides 94, which expand with increasing temperatures (See FIGS. 10A-10C). Although the slider 92 has a number of heat fins 92(a), the presence of the heat fins 92(a) may be insufficient to dissipate the heat generated by the activity of the slider 92. This deviation would usually apply stress to the linear guides 94, which therefore would need to be more robust. The higher robustness means higher expense and usually lower performance due to increased weight. The design of the slider assembly 90 avoids this situation by a providing a design which allows the mount to expand while keeping the applied stress to a tolerable value. This is achieved at least in part by a flexible machined portion 98(b) integrally formed with respect to or coupled to the main body 98(a) of the guide support element 98 which is flexible in the direction of the thermal expansion (see FIGS. 10(b), 10(c), 11(a) and 11(b)). Because this portion 98(b) is flexible, the guide support element 98 can move when parts of the guide support element thermally expand and contract. This reduces the stress in the guide support element 98 and improves the reliability of the slider assembly.

FIGS. 10B-10C show thermal profiles of sliders in a starting situation and during operation when heat is generated. FIG. 10B depicts the guide support element 98 at room temperature, before the operation started. FIG. 10C depicts the guide support element 98 during operation, when the heat causes a deformation. The flexible element 98(b) stays in the same position, although the guide support element may be deformed up to 0.15 mm.

As shown in FIG. 10(c), the flexible portion 98(b) of the guide support element 98 may include a stem 98(b)-2 and a platform 98(b)-1 integrally formed with or coupled to the stem 98(b)-2. The platform 98(b)-1 may provide a support for the linear guide 94 and provides a large area for heat transfer. The stem 98(b)-2 can flex in response to the expansion and/or contraction of the slider assembly components as they heat and cool during operation.

Other embodiments of the invention are directed to X-Y gantry systems that comprise an X-axis element comprising a casted structure, a slider bar comprising a plurality of magnets, and a first guide element. The slider bar may have a U-shaped construction, instead of being a cylindrical bar as in prior embodiments. The system also includes a Y-axis element comprising a slider assembly and a second guide element moveably coupled to the first guide element. The slider assembly comprises an electromagnetic device spaced from the first guide element. In such embodiments, the potential for abrasion is reduced because the slider assembly is spaced from the slider bar is slideably engaged with it and does not contact it.

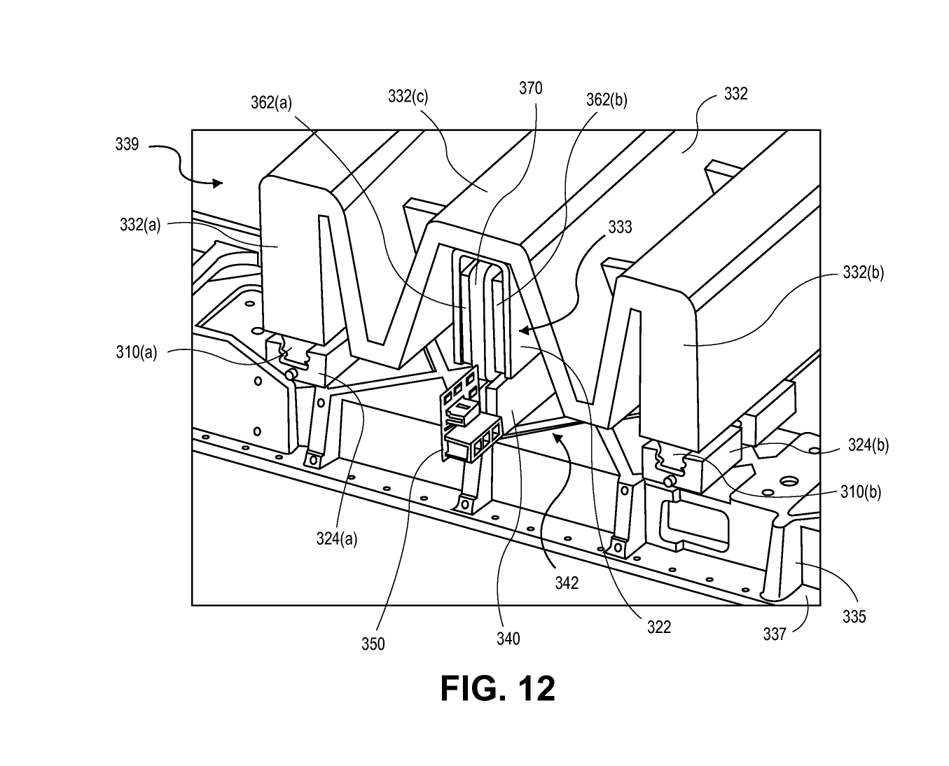

FIG. 12 shows a perspective view of a portion of an X-Y gantry system according to an embodiment of the invention. As in prior embodiments, the X-Y gantry system comprises an X-axis element 339 and a Y-axis element 337 perpendicular to the X-axis element 339, and the Y-axis element 339 can move perpendicularly with respect to the X-axis element 339. The X-axis element 339 comprises a plurality of first guide elements 310(a), 310(b) movably coupled to and cooperatively structured with a plurality of second guide elements 324(a), 324(b) attached to a holding frame 335 in the Y-axis element 337. The first guide elements 310(a), 310(b) may be male connection fittings while the second guide elements 324(a), 324(b) may be female connection fittings. Although pairs of first and second guide support elements are shown, it is understood that there can be more or less guide support elements in other embodiments of the invention.

This embodiment utilizes a U-shaped magnetic slider bar 333 that is vertically oriented, and is coupled to and under a casted structure 332 in the X-axis element 339. The casted structure 332 has an undulated profile (viewed from an axial cross-section) comprising outer peaks 332(a), 332(b) and an inner peak 332(c) between the outer peaks 332(a), 332(b). The slider bar 333 comprises a U-shaped support 322 which has an outer surface which is attached to the bottom surface of the inner peak 332(c). Magnets 362(a), 326(b) are attached to the inner surfaces of the U-shaped support 322.

A slider assembly 342 comprises a slider comprising an electromagnetic device 370 is attached to the Y-axis element 337 and resides between the magnets 362(a), 362(b). The slider assembly 342 comprises a PCB (printed circuit board) 350, and a guide support element 340 coupled to the slider comprising the electromagnetic device 370.

The slider comprising the eletromagnetic device 370 can be spaced from and does not contact the magnets 362(a), 362(b) as the slider slides along the slider bar 333. An internal circuit (not shown) may drive the electromagnetic device in a predetermined manner so that the Y-axis element 337 moves perpendicularly with respect to the X-axis element 339.

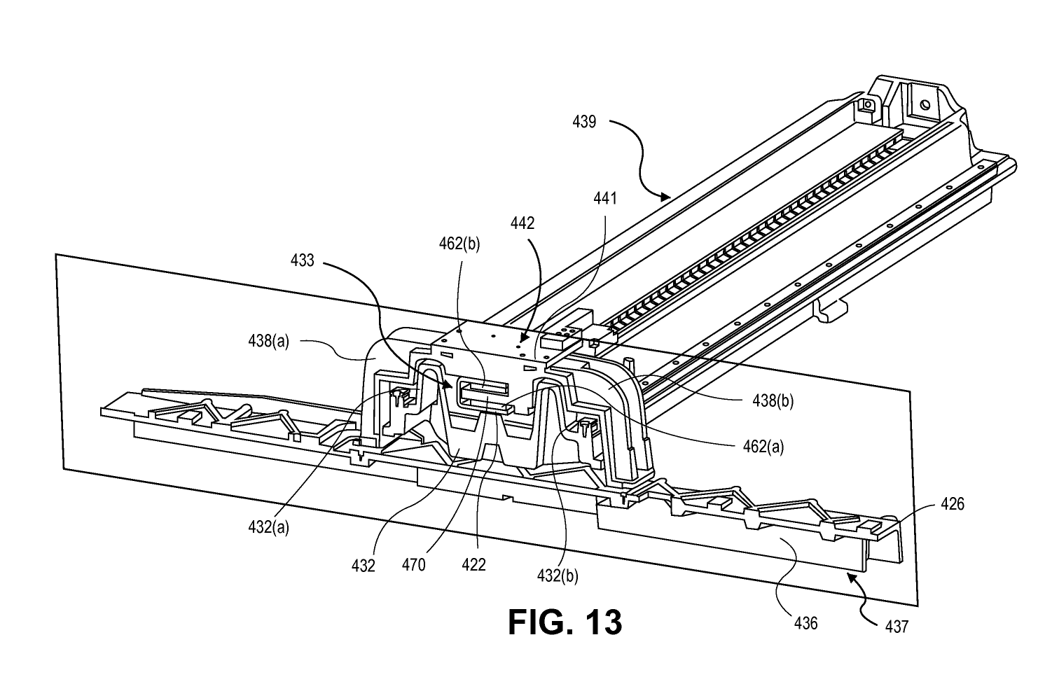

FIG. 13 shows a cross-sectional perspective view of an X-Y gantry system according to an embodiment of the invention. As in prior embodiments, the X-Y gantry system comprises an X-axis element 439 and a Y-axis element 437 perpendicular to the X-axis element 439, and the Y-axis element 439 can move perpendicularly with respect to the X-axis element 439. The X-axis element 439 comprises a plurality of guide support elements 438(a), 438(b) coupled to a slider assembly 442. The slider assembly 442 comprises a main body 441 coupled to and between the guide support elements 438(a), 438(b), and a slider comprising an electromangetic device 470. The guide support elements 438(a), 438(b) may be coupled to the holding frame 436.

The X-axis element 439 comprises a U-shaped magnetic slider bar 433 comprising a U-shaped support 422, and a plurality of magnets coupled to an inner surface of the U-shaped support 422. The U-shaped magnetic slider bar 422 lies between two peaks 432(a), 432(b) formed in the casted structure 432. In this embodiment, the U-shaped magnetic slider bar 422 is horizontally oriented and is over the casted structure 432.

The slider comprising the electromagnetic device 470 is spaced from and does not contact the magnets 462(a), 462(b) as the slider slides along the slider bar 433. An internal circuit (not shown) may drive the electromagnetic device in the slider 470 in a predetermined manner so that the Y-axis element 437 moves perpendicularly with respect to the X-axis element 439.

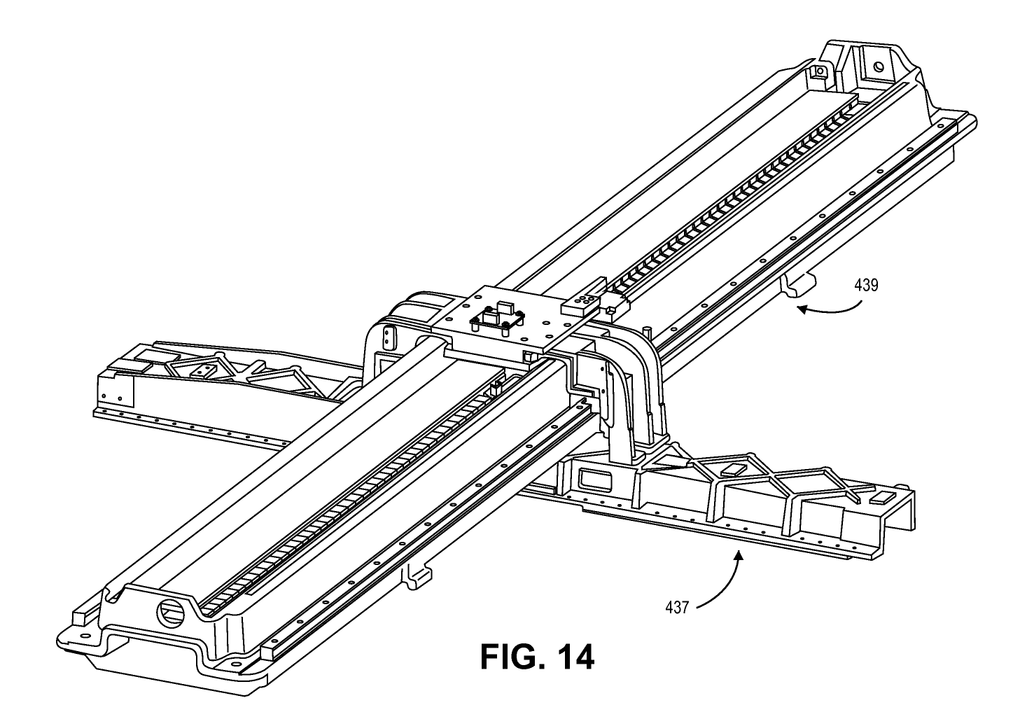

FIG. 14 shows a perspective view of the X-Y gantry system shown in FIG. 13.

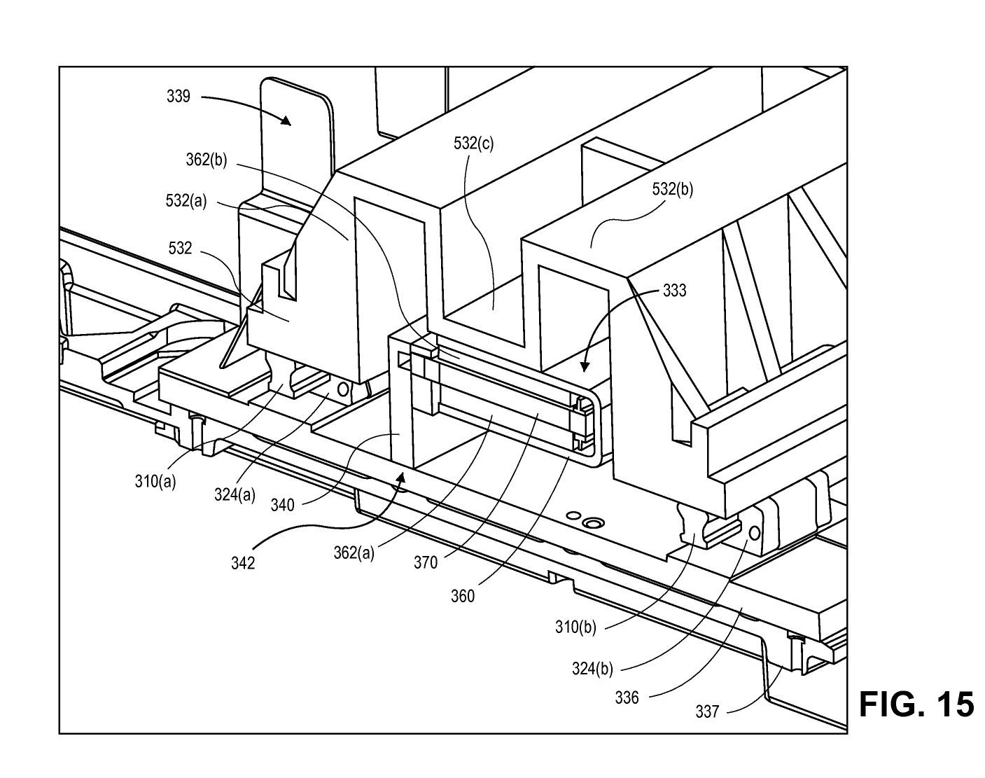

FIG. 15 shows a cross-sectional perspective view of an X-Y gantry system according to an embodiment of the invention. In this embodiment, the U-shaped magnetic slider bar is horizontally oriented, and is under the casted structure of the X-axis element.

As in prior embodiments, the X-Y gantry system comprises an X-axis element 339 and a Y-axis element 337 perpendicular to the X-axis element 339, and the Y-axis element 339 can move perpendicularly with respect to the X-axis element 339. The X-axis element 339 comprises a plurality of first guide elements 310(a), 310(b) movably coupled to and cooperatively structured with a plurality of second guide elements 324(a), 324(b) attached to the connection plate 336 in the Y-axis element 337.

The X-axis element 337 comprises a casted structure 532, which has a different shape than the previously described casted structures. The casted structure 532 includes two peaks 532(a), 532(b) with a valley 532(c) between the peaks 532(a), 532(b). The U-shaped magnetic slider bar 333 comprises a U-shaped support 360 and a number of magnets 362(a), 362(b) coupled to the U-shaped support 360.

The slider assembly 342 may include a guide support element 340 coupled to a slider comprising an electromagnetic device 370. The guide support element 340 is in turn coupled to a connection plate 336 of the Y-axis element 337.

The slider comprising the eletromagnetic device 370 is spaced from and does not contact the magnets 362(a), 362(b). An internal circuit (not shown) may drive the electromagnetic device in the slider 370 in a predetermined manner so that the Y-axis element 337 moves perpendicularly with respect to the X-axis element 339.

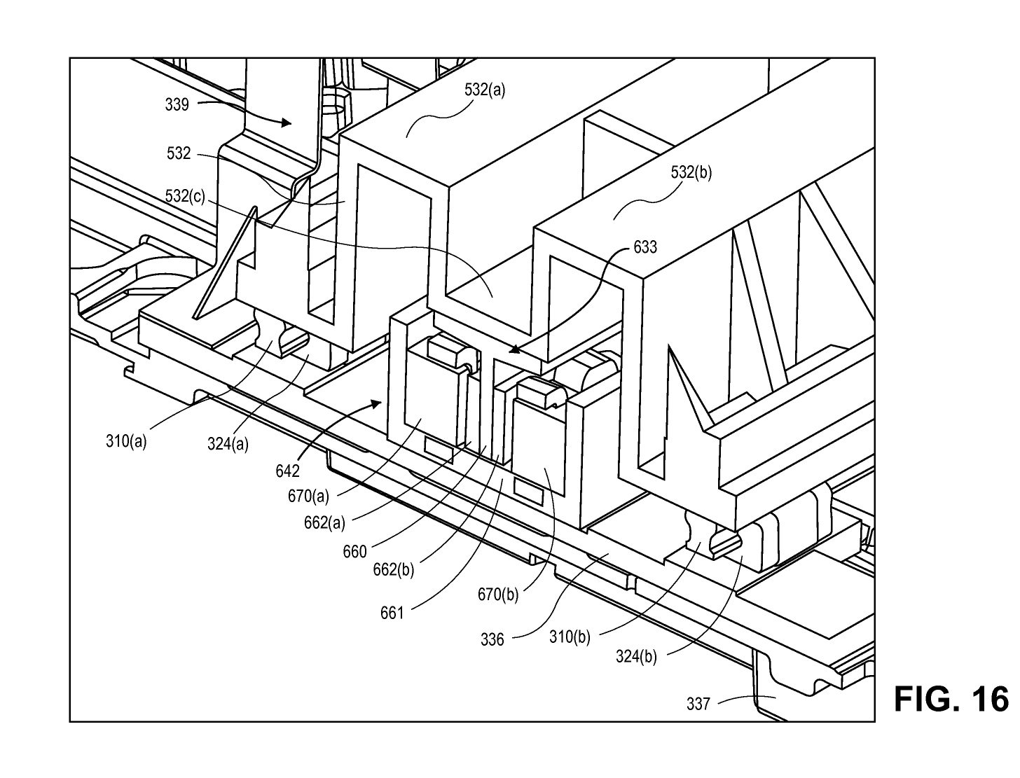

FIG. 16 shows a cross-sectional perspective view of an X-Y gantry system according to an embodiment of the invention. This embodiment utilizes a T-shaped magnetic slider bar that is under a casted structure.

As in prior embodiments, the X-Y gantry system comprises an X-axis element 339 and a Y-axis element 337 perpendicular to the X-axis element 339, and the Y-axis element 339 can move perpendicularly with respect to the X-axis element 339. The X-axis element 339 comprises a plurality of first guide elements 310(a), 310(b) movably coupled to and cooperatively structured with a plurality of second guide elements 324(a), 324(b) in the Y-axis element 337.

The X-axis element 337 comprises a casted structure 532, similar to the casted structure shown in FIG. 15. The casted structure 532 includes two peaks 532(a), 532(b) with a valley 523(c) between the peaks 532(a), 532(b).

The T-shaped magnetic slider bar 633 comprises a T-shaped support 660 and a number of magnets 662(a), 662(b) coupled to the vertical portion of the T-shaped support 660. The cross-bar of the T-shaped support 660 is coupled to the bottom portion of the casted structure 532 forming the valley 532(c).

The slider assembly 642 may include a U-shaped guide support element 661 coupled to a pair of electromagnetic devices 670(a), 670(b) in a slider. The guide support element 661 is in turn coupled to a connection plate 336 of the Y-axis element 337.

The electromagnetic devices 670(a), 670(b) are spaced from and do not contact the magnets 362(a), 362(b). An internal circuit (not shown) may drive the electromagnetic devices 362(a), 362(b) in a predetermined manner so that the Y-axis element 339 moves perpendicularly with respect to the Y-axis element 337.

The X-Y gantry systems described with respect to FIGS. 12, 15, and 16 include a pair of first guide elements coupled to the casted structure and a pair of second guide elements coupled to a holding frame, via a thermal expansion member. The pair of first guide elements slide with respect to the pair of second guide elements. The thermal expansion member reduces thermal expansion effect caused by the sliding of the pair of first guide elements with the pair of second guide elements. The thermal expansion member may take any suitable form, and may include the connection plate 336 shown in FIG. 16.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. For example, it is understood that the slider assembly and any of its components shown in FIGS. 9-11 may be used in any of the X-Y gantry systems specifically described in this application, without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. An X-Y gantry system comprising:
an X-axis element comprising a casted structure, a slider bar parallel to the casted structure, and a slider slidably engaged with the slider bar;
a Y-axis element coupled to the X-axis element; and
an instrument coupled to the Y-axis element,
wherein the slider bar in the X-axis element is on a side of the casted structure opposite the instrument.

2. The X-Y gantry system of claim 1 wherein the casted structure comprises a valley and the slider bar lies within the valley.

3. The X-Y gantry system of claim 1 wherein the casted structure is substantially flat, and comprises a pair of linear rails.

4. The X-Y gantry system of claim 1 further comprising a plurality of sliders on the slider bar.

5. The X-Y gantry system of claim l further comprising a guide support element coupling the Y-axis element to the slider, wherein the guide support element is temporarily coupled to the slider.

6. The X-Y gantry system of claim 1 further comprising a guide support element coupling the Y-axis element to the slider, wherein the guide support element is temporarily coupled to the slider and comprises a flat portion and opposing legs, the opposing legs coupled to a casted structure in the Y-axis element.

7. The X-Y gantry system of claim 1 wherein the instrument is at least one of a pipettor and a robotic arm which is capable of moving in a Z-direction.

8. The X-Y gantry system of any of claim 1, wherein the slider is a first slider and the slider bar is a first slider bar, and the Y-axis element comprises a second slider bar and a second slider.

9. The X-Y gantry system of any of claim 1, wherein the slider is a first slider and the slider bar is a first slider bar, and wherein Y-axis element comprises a second slider bar and a slider assembly, wherein the slider assembly comprises a second slider and a guide support element coupled to the second slider.

10. The X-Y gantry system of claim 9 wherein the guide support element comprises a flexible portion that flexes in response to changes in thermal expansion.

11. A method of using the X-Y gantry system of claim 1 comprising:
moving the instrument using the Y-axis element; and
moving the instrument using the X-axis element.

12. The method of claim 11 further comprising:
moving the instrument in a Z-direction.

13. A slider assembly comprising:
a slider; and
a guide support element coupled to the slider, the guide support element comprising a main body and a flexible portion extending away from the main body.

14. The slider assembly of claim 13 wherein the slider comprises an aperture configured to receive at least a part of a slider bar.

15. The slider assembly of claim 13 further comprising a plurality of linear guides coupled to the main body.

16. The slider assembly of claim 13 further comprising connecting device for connecting the main body to an instrument.

17. A X-Y gantry system comprising:
an X-axis element comprising a casted structure, a slider bar comprising a plurality of magnets, wherein the slider bar is parallel to and coupled to the casted structure, and a slider having an electromagnetic device; and
a Y-axis element coupled to the X-axis element, and comprising a holding frame,
wherein the slider is proximate to the slider bar and is capable of sliding along the slider bar without physically contacting the slider bar.

18. The X-Y gantry system of claim 17 wherein the casted structure comprises an undulated shape, and wherein the slider bar is under the casted structure.

19. The X-Y gantry system of claim 17 further comprising a pair of first guide elements coupled to the casted structure and a pair of second guide elements coupled to the holding frame, via a thermal expansion member, wherein the pair of first guide elements slide with respect to the pair of second guide elements, and wherein the thermal expansion member reduces thermal expansion effect caused by the sliding of the pair of first guide elements with the pair of second guide elements.
